(19) United States
(12) Patent Application Publication
(10) Pub. No.: US 2012/0196263 A1
(43) Pub. Date: Aug. 2, 2012

(54) INTERACTIVE EDUCATIONAL DEVICE AND METHOD OF USE

(75) Inventors: Marcel Prevuznak, Charleston, SC (US); Barry Wright, III, Charleston, SC (US); Rebecca Hughes, Charleston, SC (US)

(73) Assignee: Quant Systems, Inc. d/b/a Hawkes Learning Systems, Charleston, SC (US)

(21) Appl. No.: 13/016,354

(22) Filed: Jan. 28, 2011

(51) Int. Cl. G09B 5/00

(52) U.S. Cl. 434/350

(57) ABSTRACT

An interactive educational device and method that provides students with activity modes in the form of instruction and exercises to be performed at a plurality of individual work stations. The invention tracks and provides information that is useful to an instructor in determining students' focus and progress. The information provided to the instructor may include, the element of the activity mode of the device the student is currently using, how long the student has been in a particular mode, and how many times the student has attempted a particular element of an activity mode. The information for each student may be updated in real time, so that at any given moment the instructor may be informed as to the student's particular activity. A “look back” for any period of time may be obtained by the instructor. The instructor receives alerts for particular events. The student may report a need for assistance, and student details may be provided to the instructor.

### FIELD OF THE INVENTION

The present invention relates to devices and methods used in education, and is more specifically directed to devices and methods that allow a person, such as an instructor or proctor, to track individual student activities from a central location.

### BACKGROUND OF THE INVENTION

Educators strive to acquire and maintain a clear picture of their students' progress, the status of each student in the learning process, and where students struggle in the process. Previously, instructors could survey the class as students are in the process of performing assignments, but this method provides the instructor with only a brief observation of each student in action, and the instructor must make assumptions based on this momentary inspection. However, little useful information is usually provided.

The instructor issues tests and quizzes to assess a student's progress, but this process yields only a snapshot at a particular point in time. Ideally, the instructor would identify where students are falling behind or struggling contemporaneously, so as to address the issue quickly, and prevent a problem from compounding.

Even when an instructor can gather enough data and statistics, the instructor then has to sort and synthesize the information in order for it to be useful. This process makes it difficult to quickly identify student learning and comprehension issues that need attention.

Students often have difficulty recounting instances where they have run into obstacles during the learning process. When the student cannot properly recount the details of an issue, instructors are impeded in providing proper assistance.

Ideally, an instructor can quickly identify each student, the location of the student, and have information as to the student's current work activity, and have information regarding the student's status in the class. This is not possible for most instructors, especially for instructors with large numbers of students, or at the beginning of a class term, before the instructor is familiar with the students.

### SUMMARY OF THE INVENTION

The present invention is an interactive educational device and method that provides students with activity modes in the form of instruction and exercises to be performed at a plurality of individual work stations. The invention tracks and provides information that is useful to an instructor in determining students' focus and progress, and in evaluating elements of activity modes that may cause students to struggle. The information provided to the instructor may include, but is not limited to, the element of the activity mode of the device the student is currently using, how long the student has been in a particular mode, and how many times the student has attempted a particular element of an activity mode. The information for each student may be updated in real time, so that at any given moment the instructor may be informed as to the student's particular activity. A “look back” for any period of time may be obtained by the instructor.

The instructor may use the tool to set rules for the device, so that the instructor receives alerts for particular events. The instructor is then immediately alerted to situations that need attention.

The invention may allow the student to report a need for assistance, as well as automatically gathering relevant details for the student. The device may allow the student to indicate the urgency of the request. A summary may indicate multiple students who need help with the same issue, so that the issue may addressed with the identified group.

The device may allow the instructor to create schematics of the classroom, which receive and display updates of student status in real time by student location. The instructor tool may also allow the instructor to define rules for creation of additional visual cues regarding student status.

### DESCRIPTION OF THE DRAWINGS

FIG. 1 is a schematic of devices used in an embodiment of the invention.

FIG. 2 is a flow diagram of an embodiment of the invention using the devices of FIG. 1.

FIG. 3 is a flow diagram of another embodiment of the invention.

FIG. 4 is a flow diagram of a further embodiment of the invention.

### DETAILED DESCRIPTION OF PREFERRED EMBODIMENTS

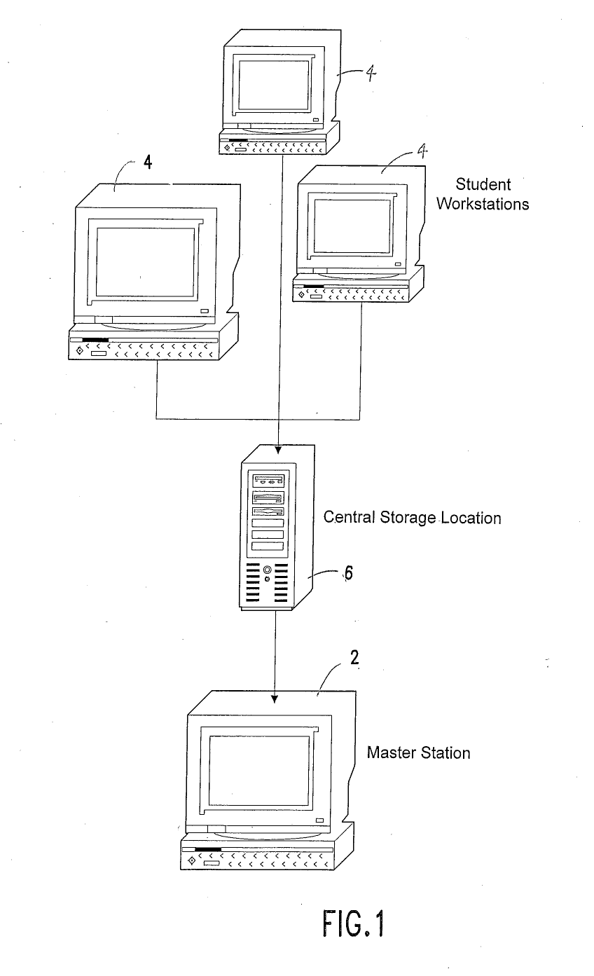

In a preferred embodiment, the present invention has a master station 2 that communicates by electronic, including wireless, connectivity to a plurality of user work stations 4. FIG. 1. The master station is monitored by a person who is typically acting in a supervisory role, and who may be an instructor. Each user work station presents to a user instructional material, such as definitions and examples, and learning exercises, such as guided exercises with immediate feedback or tests for evaluation, for a user, who may be a student, to perform. The content of the instructional material may vary according to the selection of the instructor or the user. Each set of instructional material and exercises, such as practice exercises with immediate feedback indicating possible errors, guided exercises leading the user through each step of the exercise, and evaluation exercises for assessment, constitutes an activity mode. Each individual activity mode will typically be confined to a subject or topic, and the activity mode may be selected by, or for, the individual user. Alternatively, all of the work stations associated with the master station may present the same instructional material to all users during a defined time period. Various activity modes may present a wide range of subjects and topics, with varying degrees of difficulty, as selected by the instructor or user.

In one embodiment, the present invention is a device that presents a user, such as a student, with instruction and with exercises to be performed. The device tracks the student's activities at a work station while using the learning device, and updates information about the user's activities, for example, by providing the information to a server 6. Activity updates may be performed at intervals that include, but are not limited to, when the student begins using the learning device for a learning session; when the student selects a particular objective or skill to study; when the student begins instruction on a topic; when the student begins working interactive examples; when the student begins working an exercise for credit, such as homework, a quiz or a test; when the student completes any of the previous listed activities, or reviews a test, or reviews his/her grades. An instructor is enabled by the device to monitor the user's activities and view the information in real time from the master station.

The master station is preferred to be programmable. In a preferred embodiment, the master station has an interface which presents the instructor with information from multiple work stations. For example, a list of names or other identifiers of each of multiple students currently using the learning device at each work station, and the activity mode of each user, is presented at the master station.

The instructor may customize the display presented by the master station, so that the information deemed by the instructor to be useful is presented. The instructor may choose to filter information from a menu by one or more items that he or she prefers, such as, but not limited to, student name, which work station the student is using, which activity mode the student is using, the amount of time, or number of times, the student has engaged the current activity mode, the amount of time or number of times that the user has engaged in a particular element of an activity mode, or by a particular range of time. The instructor may also choose how the display of the chosen information is sorted. For example, the instructor may select sorting of information by the user's most recent change in activity mode, current mode, amount of time spent in an activity, student name or other identifier (‘name’), or work station identifier, such as work station location or number. It is preferred that the master device presents access to other relevant information, such as each student's historical performance record (such as grades, test scores and/or attendance), work station location, and historical activity mode data for a period of time that is variably selectable by the instructor.

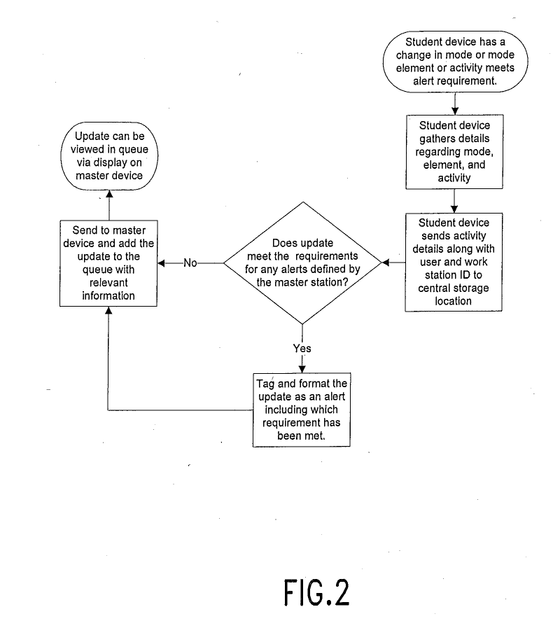

The instructor can also program the master station to send real-time communications to a selected work station. The real time communication may be an alert, such as the amount of time remaining to complete an activity mode, or information pertaining to an element of the activity mode. FIG. 2.

The instructor may use the master station to set rules. Once an activity or event occurs that meets the parameters of the rule, an alert is sent in real-time to the master device, where the alert is capable of being received by the instructor. By way of example, the instructor may set a rule indicating the maximum time that a particular user, or group of users, should spend on an exercise, as spending an excessive amount of time on a particular exercise could indicate the user is struggling and in need of assistance. An alert would then be sent to the instructor via the master device when a user exceeds the allotted amount of time for an exercise. In another example, alerts may correspond to a maximum number of attempts to answer a question presented during an activity mode, as an excessive number of failed attempts could also indicate a need for assistance. Alerts may appear visually different in some manner to differentiate them from activity updates.

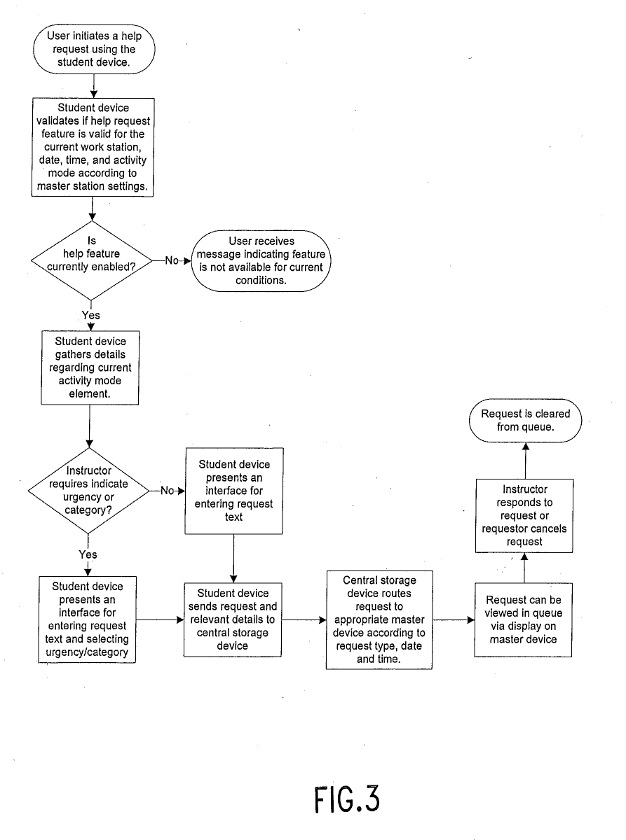

In another embodiment, the invention provides users with the ability to request assistance at a moment or point of difficulty by means of the user work station's connectivity with the instructor and/or master station. The instructor may also, through instructions to the master station, have the option to limit how and when a student may request assistance. In one scenario, the instructor may limit the user's ability to request help to certain activity modes, or portions thereof, such as when the student is completing interactive examples but not when performing exercises for credit such as on a test. In another scenario, the instructor may limit the user's ability to request help to certain days and/or times, such as only during required lab hours. FIG. 3.

The instructor, through the master station, may choose to allow the student to include a message and indicate the urgency of the request from the student's work station. The instructor may use predefined categories, or in another embodiment, the instructor may use the master station to define categories or levels of urgency for the requests. The work station users are required, in this case, to select the most relevant category for their request. Categorization of the requests may assist the instructor in organizing and prioritizing the requests. Giving the instructor the ability to define personalized, distinct categories is less subjective than non-defined levels of urgency. By way of example, the instructor may define categories for the user work stations, such as “Report error, prevents further work”, “Report error, does not prevent continuing work”, “Request help with this exercise”, and “General question”. With these categories, priorities are established, and a student that cannot continue working because of a system error is highest urgency, rather than relying on the user's subjective indication of the urgency of the request.

The instructor may also select how requests are routed to the master station or other device to which requests are sent. The requests may be routed according, but not limited to, days, times, sending work station, or type. In one embodiment, the instructor chooses to have help requests sent to different devices according to day, time, and work station sending the request. By way of example, if lab students are required to attend at a certain time, the instructor may select requests sent from the lab work stations at that particular time to be routed to a portable handheld device, so that the instructor may move around the lab as he responds to student requests.

In all embodiments herein, mobile devices may communicate with a central device 6, such as a server or master station, that receives information from the work stations. The master station may comprise, or communicate, with a server.

In another embodiment, a teaching assistant has predetermined hours. The instructor may define the master station or server to direct student requests to a secondary master station used by the teaching assistant during those times. In yet another embodiment, the instructor may cause the device to route user requests to particular instructors or assistants by subject matter or type of inquiry. By way of example, if the request is for assistance in solving an exercise he may route the request to a teaching assistant. If the request relates to a technical error with the hardware or software system, he may route the request to technical assistant.

Once a student initiates a request, the device may retrieve and present relevant information about a user who requests assistance. The information may include, but is not limited to, the student's name, a unique identifier of the work station, a current activity mode (such as instruction, practice exercises or homework exercises and which objective or skill the activity relates to) and/or element of the activity mode (such as the particular instruction or exercise). In one embodiment, the user is provided with an interface displayed at the work station to enter a brief question or description of the issue. In one embodiment, the student is able select the urgency or category of the request.

In another embodiment, the student is able to view and manage his/her request(s). The student may view and edit pending request(s). The student may see the number of requests queued ahead of his request(s); thus allowing the student a sense of wait time, and yielding less frustration due to wait time in receiving assistance. The student may see how long his request has been pending. Additionally, the student may cancel the request if assistance is no longer required, such as when the student independently determines the solution.

When a student submits a request, the request may be routed to a predetermined master station, as chosen by an instructor or proctor. The receiving master station may be used to manage requests. The master station may receive requests and place the requests in a queue according to order received. A display is provided for viewing the queue at the master station. Each request or item that is present in the queue is preferred to have information relevant to the request associated with the request, providing information that is useful in responding to the request. This information may include, but is not limited to, the student's name, the unique identifier of the work station where the student is located, the current activity mode of the device (such as general instruction or exercise) and the details of the current element of the activity mode (such as the specific exercise the student is performing), the content of the student message, the assigned urgency, the time in queue, information about the user and their performance history, such as a link to the student's academic record, and a link to a student locator. The user information may also include, but is not limited to, information such as an e-mail address, activity logs, test results, grades, and class attendance.

To help manage requests, the instructor may, through the master station, sort and group requests as necessary, such as by time received, urgency, category, student name, or activity mode. In one embodiment, the instructor uses the information in the queue to respond to requests in a fair and unbiased manner, such as the order received. In another scenario, the instructor uses the information to respond to requests according to assigned priority. In another scenario, the instructor uses the summary information to respond to requests in a more efficient manner. By way of example, if several users request assistance with the same exercise, the instructor may assist these students as a group, rather than individually. After the instructor has responded to the student's request, the interface is used to then clear the request from the queue.

The master station interface may also provide the instructor with summary data for the requests received. In one embodiment, the instructor may customize the summary data. The instructor chooses sets of data for the device to summarize, and may select a time period for the data. In one embodiment, the instructor may reset the data at any point in time, so that the summarized data is relevant to that time going forward. In another embodiment, the instructor may choose to see only the summarized data for requests currently in the queue. In yet another embodiment, the instructor may choose to view summarized data for any selected time period, for example, by indicating a starting date and time and an ending date and time.

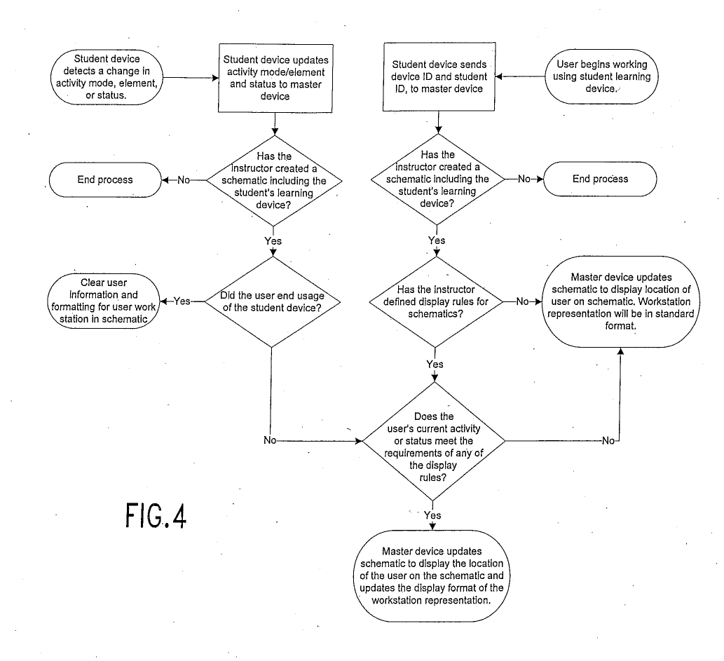

It is preferred that each work station 4, and the learning device associated with each work station, has a unique identifier which it communicates to the master station and/or to a server and/or central storage location 6. The identifier allows the instructor to create a schematic of the work stations, indicating the location of each. Each representation of a work station may be associated with the unique identifier of that learning device. The instructor may create schematics for multiple classrooms and labs as necessary. The schematics may be saved to a central location so that they are accessible from any device with access to the central location. FIG. 4.

The work stations may communicate additional information, such as student information and usage of the device. This information may be communicated to the master station and/or to the central location and displayed in the schematic. For example, the device may indicate which student is using the device and activity mode of the student. The instructor may view the schematic of the classroom to see where students are physically located, and the activity mode of each.

The schematic display facilitates inquiries of, and access to, information stored on a server. The instructor can access this information directly or through the use of the schematic. By way of example, where scores or other historical performance information for students have been stored in a central location, the instructor may access this information by locating the student in the schematic display and requesting the information from the server.

Additionally, the instructor may define rules regarding formatting and display of the device representations in the schematic. The instructor can define conditional statements based on any of the information accessible from the central locations. The visual appearance, such as color or geometric shape, is be determined by whether the device or student using the device does or does not satisfy the condition. By way of example, the instructor may define a rule that if the student using a work station has a class average of greater or less than defined parameter(s), the representation of the work station in the schematic is color coded. By way of further example, below a first performance score, a student is associated with red, and within a certain performance score range, a student is associated with blue, and above the range, the student is associated with green.

The schematic may be used to group information. For example, students in certain groups, such as age or other demographics, or students with certain minimum historical performance measures, such grades or tests scores, may be selected, and the members of the group are displayed by location or on the selected schematic, and may be displayed with indicators such as geometric shapes and/or colors. Students working on a particular activity may be grouped and displayed by location on the schematic.

What is claimed is:

1. An interactive educational device, comprising:
a) a programmable master station comprising a display;
b) a plurality of work stations, each of which communicates with the master station or central location accessible by the master station;
wherein the programmable master station is programmed to selectively display a name of a user of each of the plurality of work stations and a mode of activity at each of the plurality of work stations, and wherein each of the plurality of work stations is constructed to communicate change in the mode of activity to the programmable master station.

2. An interactive educational device as described in claim 1, wherein the programmable master station displays a change in mode of activity for each of the plurality of work stations.

3. An interactive educational device as described in claim 1, wherein the programmable master station displays a list of conditions sortable by user command, said list comprising two of the following conditions existing at one or more of the plurality of work stations: a change in activity at a work station; a current mode of activity; and a name of a user.

4. An interactive educational device as described in claim 1, wherein the programmable master station displays a list filterable by user command, said list comprising two of the following conditions existing at one or more of the plurality of work stations at a work station a current mode of activity; a name of a user;
date and time; learning skill; learning objective; user's instructor's identifier;
user's class identifier.

5. An interactive educational device as described in claim 1, wherein the programmable master station displays on command for each work station of the plurality of work stations a name of a user of a work station, historical academic performance information for the user, and work station identification information, and the elapsed time in the mode of activity at each of the plurality of work stations.

6. An interactive educational device as described in claim 1, wherein the programmable master station displays an alert that is initiated by a user's performance at a work station, said alert determined according to a predetermined performance standard for a mode of activity in current use at a work station.

7. An interactive educational device as described in claim 1, wherein the programmable master station displays an element of the mode of activity at a work station.

8. An interactive educational device as described in claim 1, wherein a work station of the plurality of work stations is constructed to allow a user at the work station to enter an inquiry, wherein said inquiry is displayed by the master station.

9. An interactive educational device as described in claim 1, wherein a work station of the plurality of work stations is constructed to allow a user at the work station to enter an inquiry and to indicate the urgency of the inquiry, wherein said inquiry is displayed by the master station.

10. An interactive educational device as described in claim 1, wherein each of the work stations of the plurality of work stations is constructed to allow a user at each of the work stations to enter an inquiry, wherein the master station prioritizes a plurality of inquiries so received, and wherein said plurality of inquiries is displayed by the master station in order of priority.

11. An interactive educational device as described in claim 1, wherein each of the work stations of the plurality of work stations is constructed to allow a user at each of the work stations to enter an inquiry, and to indicate the urgency of the inquiry, wherein the master station prioritizes a plurality of inquiries so received, and wherein said plurality of inquiries is displayed by the master station in order of priority.

12. An interactive educational device as described in claim 1, wherein each of the work stations of the plurality of work stations is constructed to allow a user at each of the work stations to enter an inquiry, wherein the master station prioritizes a plurality of inquiries so received, and wherein said plurality of inquiries is displayed by the master station in order of priority, and wherein the master station displays for each of the inquiries one or more items of information selected from the following: a user's name; a work station identifier; the mode of activity for the work station, the element of the mode of activity associated with the inquiry.

13. An interactive educational device as described in claim 1, wherein each of the work stations of the plurality of work stations is constructed to allow a user at each of the work stations to enter an inquiry, and to indicate the urgency of the inquiry, wherein the master station prioritizes a plurality of inquiries so received, and wherein said plurality of inquiries is displayed by the master station in order of priority and wherein the master station displays for each of the inquiries one or more items of information selected from the following: a user's name; a work station identifier; the mode of activity for the work station, the element of the mode of activity associated with the inquiry.

14. An interactive educational device as described in claim 1, wherein a work station of the plurality of work stations is constructed to allow a user at the work station to enter an inquiry, wherein said inquiry is displayed by the master station, and wherein the master station displays the name of the user making the inquiry, historical academic performance information for the user, and work station identification information.

15. An interactive educational device as described in claim 1, wherein a work station of the plurality of work stations is constructed to allow a user at the work station to enter an inquiry, wherein said inquiry is displayed by the master station, and wherein the master station displays the name of the user making the inquiry, historical academic performance information for the user, work station identification information, and the elapsed time in the mode of activity at the work station.

16. An interactive educational device as described in claim 1, wherein communication of a portion of the plurality of work stations with the master station is disabled by the master station.

17. An interactive educational device as described in claim 1, wherein communication of a portion of the plurality of work stations with the master station is disabled when said portion of the plurality of work stations are in a predetermined mode of activity.

18. An interactive educational device as described in claim 1, wherein communication of a portion of the plurality of work stations with the master station is disabled during a predetermined time period.

19. An interactive educational device as described in claim 1, wherein each of the work stations of the plurality of work stations is constructed to allow a user at each of the work stations to enter an inquiry, wherein the master station prioritizes a plurality of inquiries received in order of receipt, and wherein said plurality of inquiries is displayed by the master station in order of priority.

20. An interactive educational device as described in claim 1, wherein each of the work stations of the plurality of work stations is constructed to allow a user at each of the work stations to enter an inquiry, wherein the programmable master station prioritizes a plurality of inquiries received according to the subject of the inquiry, and wherein said plurality of inquiries is displayed by the master station in order of priority.

21. An interactive educational device as described in claim 1, wherein a physical location of each of the plurality of work stations is communicated to the master station.

22. An interactive educational device as described in claim 1, wherein a physical location of each of the plurality of work stations is communicated to the master station, and a schematic showing the physical locations of each of the plurality of work stations is displayed by the master station.

23. An interactive educational device as described in claim 1, wherein a physical location of each of the plurality of work stations is communicated to the master station, wherein the master station displays the physical location of a work station of the plurality of work stations, a current mode of activity at the work station, and a name of a user at the work station.

24. An interactive educational device as described in claim 1, wherein a physical location of each of the plurality of work stations is communicated to the master station, wherein the master station displays the physical location of a work station of the plurality of work stations, a current mode of activity at the work station, and a name of a user at the work station, and historical information regarding the user's academic performance.

25. An interactive educational device as described in claim 1, wherein a physical location of each of the plurality of work stations is communicated to the master station, wherein the master station displays the physical location of a work station of the plurality of work stations, a current mode of activity at the work station, and a name of a user at the work station, and the elapsed time of the current mode of activity at the work station.

26. An interactive educational device as described in claim 1, wherein a physical location of each of the plurality of work stations is communicated to the master station, wherein the master station displays the physical location of a work station of the plurality of work stations, a current mode of activity at the work station, and a name of a user at the work station, and wherein the display codes the work station according to rules applied to the user.

27. An interactive educational device as described in claim 1, wherein each of the work stations of the plurality of work stations is constructed to allow a user at each of the work stations to enter an inquiry, wherein the master station prioritizes a plurality of inquiries received, wherein said plurality of inquiries is displayed by the master station in order of priority, and wherein each of said plurality of inquiries is marked as completed after an associated inquiry is satisfied.

28. An interactive educational device as described in claim 1, wherein each of the work stations of the plurality of work stations is constructed to allow a user at each of the work stations to enter an inquiry, wherein the master station prioritizes a plurality of inquiries received, and wherein said plurality of inquiries is displayed by the master station in order of priority, and wherein the master station prepares a summary of inquiries received.

29. An interactive educational device as described in claim 1, wherein the programmable master station displays an alert that is initiated by a user's performance at a work station, said alert determined according to a predetermined performance standard for a mode of activity in current use at a work station, wherein the predetermined performance standard is programmed at the programmable master station.

30. An interactive educational device as described in claim 1, wherein each of the work stations of the plurality of work stations is constructed to allow a user at each of the work stations to enter an inquiry, wherein the programmable master station prioritizes a plurality of inquiries received according to the subject of the inquiry, and wherein said plurality of inquiries is displayed by the master station in order of priority, wherein a rank of priorities is selectively programmed into the programmable master station.

31. An interactive educational device as described in claim 1, wherein each of the work stations of the plurality of work stations is constructed to allow a user at each of the work stations to enter an inquiry, and wherein the user can delete the inquiry.

32. An interactive educational device as described in claim 1, wherein each of the work stations of the plurality of work stations is constructed to allow a user at each of the work stations to enter an inquiry, and wherein the master station communicates queuing information for inquiries received from the plurality of work stations.

33. An interactive educational device as described in claim 1, wherein a physical location of each of the plurality of work stations is communicated to the master station, wherein the master station displays the physical location of a work station of the plurality of work stations, wherein the display codes the work station according to rules applied to the user, and wherein the rules are programmed into the master station.

34. An interactive educational device as described in claim 3, wherein the list of conditions sortable by user command further comprises at least one of the following additional conditions: date and time, learning skill in use; learning objective in use; user's instructor's identifier, user's class identifier.
